(19) United States
(12) Patent Application Publication
(10) Pub. No.: US 2010/0091409 A1
(43) Pub. Date: Apr. 15, 2010

(54) HEAD GIMBAL ASSEMBLY AND ACTUATOR HAVING THE SAME IN HARD DISK DRIVE

(75) Inventors: Joseph Chang, Naju-si (KR); Dae-wee Kong, Yongin-si (KR); Youn-tai Kim, Hwaseong-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/575,690

(22) Filed: Oct. 8, 2009

(30) Foreign Application Priority Data
Oct. 13, 2008 (KR) 2008-100193

(51) Int. Cl. G11B 5/48

(52) U.S. Cl. 360/245.3; G9B/5.147

(57) ABSTRACT

A gimbal head assembly and an actuator having the same, the gimbal head assembly and the actuator being included in a hard disk drive (HDD). The actuator can include a swing arm rotatably installed on a base member, the head gimbal assembly elastically biasing a read/write head towards a surface of a disk, and a voice coil motor rotating the swing arm. The head gimbal assembly can include a load beam attached to the swing arm, a flexure attached to the load beam, a slider mounted on a slider mounting portion of the flexure and comprising a read/write head installed on the slider, and an air foil disposed in front of the slider and guiding air flow generated due to rotations of the disk along both sides of the slider. The air foil reduces turbulent air flow in the vicinity of the slider, thereby reducing oscillations of the slider due to the turbulent air flow

### CROSS-REFERENCE TO RELATED APPLICATIONS

This application claims the benefit of Korean Patent Application No. 10-2008-0100193, filed on Oct. 13, 2008, in the Korean Intellectual Property Office, the disclosure of which is incorporated herein in its entirety by reference.

### BACKGROUND

1. Field of the Invention

The general inventive concept relates to a hard disk drive (HDD), and more particularly, to a head gimbal assembly that supports a slider on which a read/write head is mounted, and an actuator to move the read/write head to a desired position on a disk.

2. Description of the Related Art

Hard disk drives (HDDs), which store information in computers, reproduce or record data on a disk using a read/write head. In such HDDs, the read/write head functions by being moved to a desired position by an actuator while being lifted above a recording surface of the rotating disk.

One of these HDDs includes a disk, a spindle motor for rotating a disk, a read/write head, and an actuator that moves the read/write head to a desired position on the disk. The actuator includes a swing arm rotatably mounted on an actuator pivot, a head gimbal assembly which is installed on a front end of the swing arm and which elastically biases a slider having the read/write head toward a recording surface of the disk, and a voice coil motor (VCM) for rotating the swing arm.

When the HDD is powered and the disk starts rotating, the VCM rotates the swing arm of the actuator in a predetermined direction so as to move the slider with the read/write head above the recording surface of the disk, and the read/write head reproduces or records data from/on the recording surface of the disk.

In the meantime, if the HDD does not operate, that is, the disk stops rotating, the VCM rotates the swing arm of the actuator in an opposite direction to the predetermined direction so as to deviate the read/write head from the recording surface of the disk. By doing so, the VCM prevents the read/write head from hitting the recording surface of the disk. The read/write head deviated from the recording surface is parked on a ramp installed outside the disk, or is parked on a parking zone provided on an inner circumference of the disk.

FIG. 1 is a perspective view of a head gimbal assembly 10 of a conventional HDD. FIG. 2 shows air flow generated in the vicinity of a slider 16 of the conventional HDD, which is above a disk when the disk rotates.

Referring to FIG. 1, the head gimbal assembly 10 includes a load beam 12 attached to a swing arm of an actuator, and a flexure 14 attached to the load beam 12 and supporting the slider 16 on which a read/write head 17 is mounted. The flexure 14 includes a slider mounting portion 15 to which the slider 16 is mounted. The slider 16 includes a front end 16a facing a direction of the air flow indicated by an arrow, and a rear end 16a adjacent to the read/write head 17.

The air flow is generated due to the rotation of the disk, and thus, an air bearing is formed between the disk and an air bearing surface 16c of the slider 16.

As illustrated in FIG. 2, the air flow collides against the front end 16a of the slider 16 having a predetermined thickness and is divided into two parts flowing along both sides of the slider 16. At this point, the air flow generates turbulent air flow in the vicinity of the slider 16. Also, the slider 16 increasingly oscillates due to the turbulent air flow generated in the vicinity of the slider 16, and accordingly, a positional error signal (PES) of the read/write head 17 increases. Thus, the reliability of the read/write head 17 deteriorates in terms of data record/reproduce performance.

In addition, the higher the rotating speed of the disk of the conventional HDD, the higher the speed of air flow acting on the slider 16. In addition, the higher the data storage capacity of the disk of the conventional HDD, the higher a track per inch (TPI). Thus, a PES increases due to turbulent air flow generated in vicinity of the slider 16.

Accordingly, in order to increase the rotating speed and TPI of a disk, turbulent air flow generated in the vicinity of the slider 16 in which the read/write head 17 is mounted needs to be minimized.

### SUMMARY

The general inventive concept provides a head gimbal assembly including an air foil to reduce turbulent air flow in the vicinity of a slider on which a read/write head is mounted, and an actuator having the head gimbal assembly.

Additional aspects and utilities of the present general inventive concept will be set forth in part in the description which follows and, in part, will be obvious from the description, or may be learned by practice of the general inventive concept.

Exemplary embodiments of the present general inventive concept provide a head gimbal assembly of a hard disk drive (HDD), elastically biasing a read/write head towards a surface of a disk, the head gimbal assembly including: a load beam attached to a swing arm of an actuator; a flexure attached to the load beam; a slider mounted on a slider mounting portion of the flexure and comprising a read/write head installed on the slider; and an air foil disposed in front of the slider and guiding air flow generated due to rotations of the disk along both sides of the slider.

The air foil may be formed by bending a portion of the flexure towards a front end of the slider.

The air foil may be connected to and supported by a neck portion extending from the slider mounting portion of the flexure.

The air foil may be formed by bending a portion of the load beam towards a front end of the slider.

The air foil may be disposed through an opening formed in the flexure so as to be disposed in front of the front end of the slider.

The head gimbal assembly may further include protruding portions formed on both edges of the slider mounting portion of the flexure, the protruding portions may extend between the air foil and the load beam, and, the air foil and the protruding portions may limit vertical displacements of the flexure and the slider.

The air foil may include an intermediate portion and wing portions extending from the intermediate portion to both ends of the air foil.

The air foil may have a circular arc shape or a shape in which the wing portions of the both ends are bent towards the slider by a predetermined angle while extending from the intermediate portion.

Exemplary embodiments of the present general inventive concept also provide an actuator of a hard disk drive (HDD), moving a read/write head to a desired position on a disk, the actuator including a swing arm rotatably installed on a base member; a head gimbal assembly that elastically biases the read/write head towards a surface of the disk; and a voice coil motor to rotate the swing arm.

Exemplary embodiments of the present general inventive concept also provide a slider to support a read/write head above a disk of a hard disk drive, the slider including: a flexible member to support the slider with respect to the disk; and an air foil member bent from an inner portion of the flexible member in front of a front portion of the slider in which air flow is directed when the disk rotates, the air foil member being bent upward to block the air flow from the front portion of the slider such that the air flows parallel along the sides of the slider.

The slider may further include protruding portions formed on both edges of the inner portion of the flexible member such that the air foil and the protruding portions limit vertical displacements of the flexible member and the slider.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a perspective view of a head gimbal assembly of a conventional hard disk drive (HDD);

FIG. 2 shows air flow generated in the vicinity of a slider of the conventional HDD of FIG. 1, which is above a disk when the disk rotates;

FIG. 3 is a plan view of an HDD including a head gimbal assembly, according to an embodiment of the present general inventive concept;

FIG. 4 is a perspective view of a head gimbal assembly according to an embodiment of the present general inventive concept;

FIG. 5 is a plan view of the head gimbal assembly of FIG. 4;

FIG. 6 is a cross-sectional view of the head gimbal assembly taken along line A-A′ of FIG. 4;

FIG. 7 shows a modified example of an air foil of FIG. 4;

FIG. 8 is a perspective view of a head gimbal assembly according to another embodiment of the present general inventive concept;

FIG. 9 is a cross-sectional view of the head gimbal assembly taken along line B-B′ of FIG. 8;

FIG. 10 shows air flow generated in the vicinity of a slider of the head gimbal assembly of FIG. 4, which is above a disk when the disk rotates; and

FIG. 11 is a graph showing a comparison between a non-repetitive runout (NRRO) positional error signal (PES) in the head gimbal assembly of FIG. 4 and the NRRO PES in the head gimbal assembly of FIG. 1.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

A head gimbal assembly and an actuator having the same, which is used in a hard disk drive (HDD), according to embodiments of the present general inventive concept, will now be described more fully with reference to the accompanying drawings, in which exemplary embodiments of the general inventive concept are shown. Like reference numerals in the drawings denote like elements.

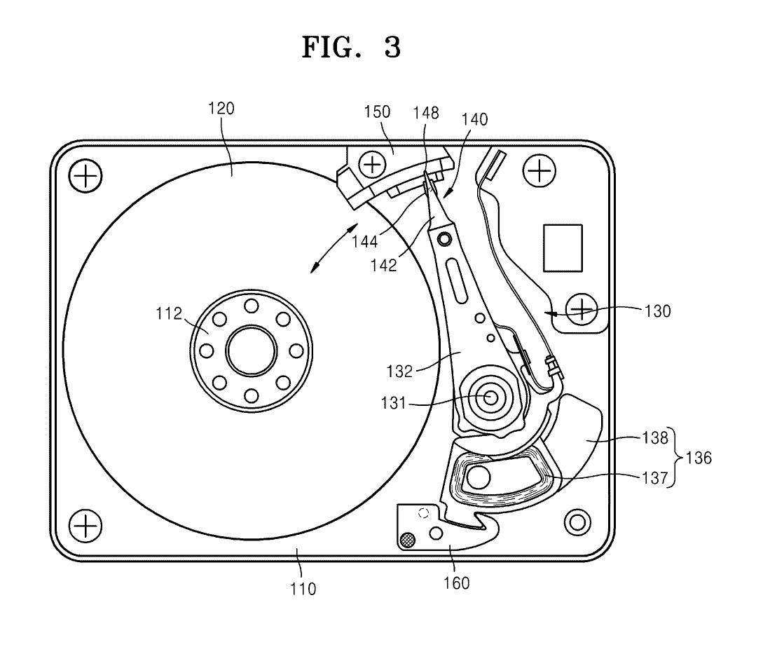

FIG. 3 is a plan view of a hard disk drive (HDD) including a head gimbal assembly 140, according to an embodiment of the present general inventive concept.

Referring to FIG. 3, the HDD includes a spindle motor 112 installed on a base member 110, at least one disk 120 loaded in the spindle motor 112 to be rotated by the spindle motor 112, and an actuator 130 to move a read/write head for data recording/reproducing to a desired portion on the disk 120. The actuator 130 includes a swing arm 132 rotatably combined with an actuator pivot 131 that is installed on the base member 110, the head gimbal assembly 140 installed on a front end of the swing arm 132 and which elastically biases a slider having the read/write head towards a surface of the disk 120 (highlight A), and a voice coil motor (VCM) 136 to rotate the swing arm 132.

The VCM 136 includes a VCM coil 137 combined with a rear end of the swing arm 132, and a magnet 138 facing the VCM coil 137. The VCM 136 is controlled by a servo control system, and pivots the swing arm 132 of the actuator 130 in a direction complying with Fleming's left hand rule due to an interaction between a current input to the VCM coil 137 and a magnetic field formed by the magnet 138. That is, if the HDD is powered on and thus the disk 120 starts rotating, the VCM 136 pivots the swing arm 132 in a predetermined direction to move the read/write head onto a recording surface of the disk 120. On the other hand, if the HDD is powered off and thus the disk 120 stops rotating, the VCM 136 pivots the swing arm 132 in an opposite direction to the predetermined direction to deviate the read/write head from the recording surface of the disk 120. The read/write head deviated from the recording surface of the disk 120 is then parked on a ramp 150 installed outside the disk 120.

A parking zone, instead of the ramp 140, may be formed on an inner circumference of the disk 120. In this case, the read/write head deviated from the recording surface of the disk 120 is parked on the parking zone.

A latch device 160 to lock the actuator 130 to a parking area may be installed in the vicinity of the rear end of the swing arm 132.

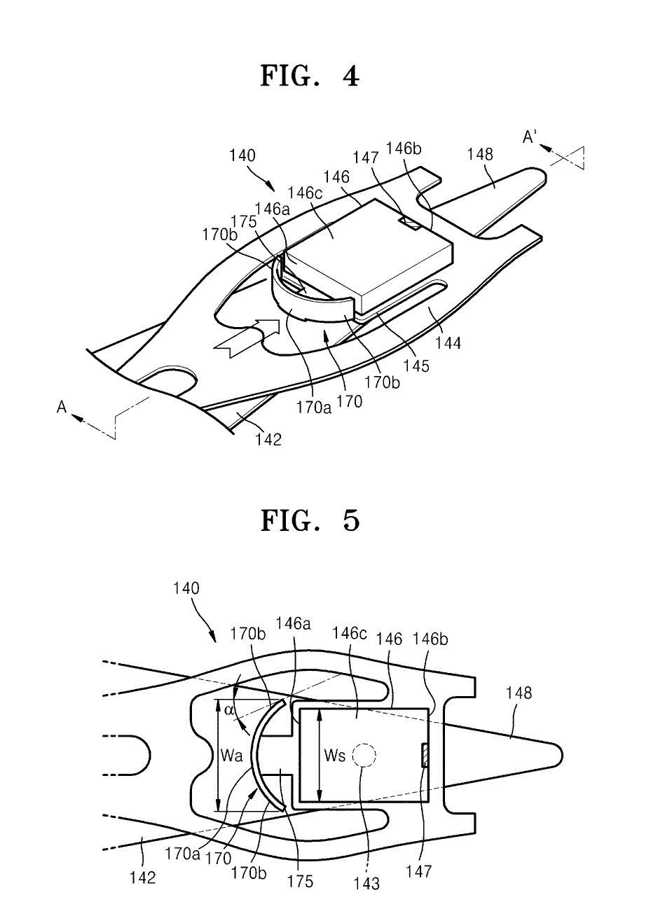

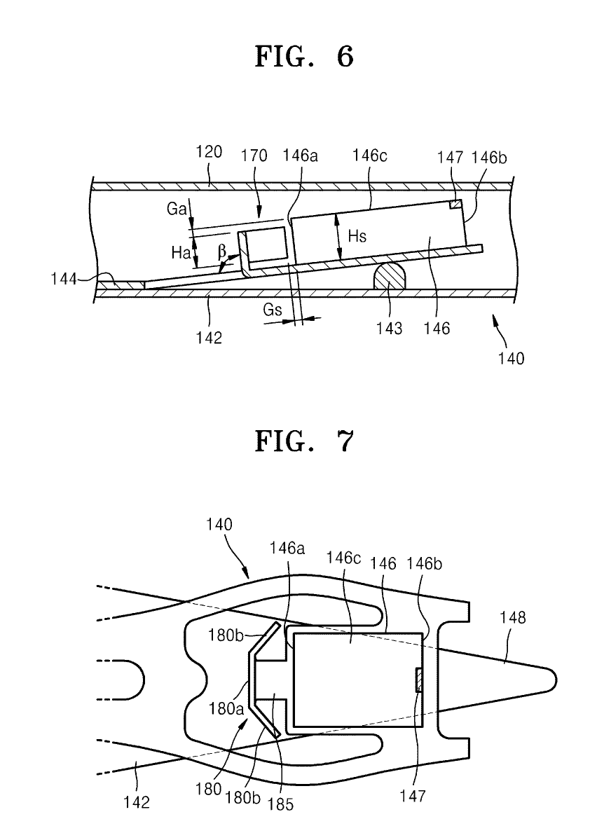

FIG. 4 is a perspective view of the head gimbal assembly 140 according to an embodiment of the present general inventive concept. FIG. 5 is a plan view of the head gimbal assembly 140 of FIG. 4. FIG. 6 is a cross-sectional view of the head gimbal assembly 140 taken along line A-A′ of FIG. 4.

Referring to FIGS. 4 through 6, the head gimbal assembly 140 includes a load beam 142 attached to the front end of the swing arm 132, a flexure 144 attached to the load beam 142, and a slider 146 attached to the flexure 144 that supports the slider 146 on which a read/write head 147 is mounted. The load beam 142 and the flexure 144 may be fabricated as a metal thin plate, for example, a stainless steel thin plate. A dimple 143 protruding from the load beam 142 is interposed between the load beam 142 and a slider mounting portion 145 of the flexure 144. The slider 146 includes a front end 146a facing a direction of air flow indicated by an arrow, and a rear end 146b adjacent to the read/write head 147, and further includes an air bearing surface 146c facing a surface of the disk 120. A tip-tab 148 may extend from a front end of the load beam 142. The tip-tab 148 contacts with the ramp 150 to be supported by the ramp 150 so that the read/write head 147 can be parked on the ramp 150. As described above, if a parking zone, instead of the ramp 150, is formed on an inner circumference of the disk 120 and the read/write head 147 deviated from the recording surface of the disk 120 is parked on the parking zone, it may not be required to form the tip-tab 148 of the load beam 142.

In the head gimbal assembly 140 having the above structure, an air foil 170 is installed in front of the front end 146a of the slider 146 to smoothly guide the air flow along both sides of the slider 146, thereby reducing the turbulent air flow in the vicinity of the slider 146.

The air foil 170 may be formed by smoothly bending a portion of the flexure 144 towards the front end 146a of the slider 146. That is, the air foil 170 is formed so as to face the front end 146a of the slider 146. In addition, the air foil 170 may have a circular arc shape as a whole. In particular, the air foil 170 is connected to and supported by a neck portion 175 extending from the slider mounting portion 145 of the flexure 144 with a narrow width. In addition, the air foil 170 includes an intermediate portion 170a connected to the neck portion 175, and wing portions 170b extending from the intermediate portion 170a toward both ends of the air foil 170.

As illustrated in FIG. 5, a width Wa of the air foil 170 may be equal to or more than width Ws of the slider 146. Such dimensions can prevent air flow flowing along both ends of the air foil 170 from colliding against the front end 146a of the slider to generate turbulent air flow. In addition, an inclination angle “α” of tangent lines to the both ends of the air foil 170 may be equal to or less than 45 degrees, and preferably, equal to or less than 25 degrees.

Referring to FIG. 6, the air foil 170 may have a height Ha so as to cover the front end 146a of the slider 146 as much as possible. In particular, the height Ha of the air foil 170 may be equal to or more than 50% of the height Hs of the slider 146, and preferably, equal to or more than 70% of the height Hs of the slider 146.

A gap Ga between a line extending from the air bearing surface 146c of the slider 146 and the air foil 170 may be as small as possible. However, if the gap Ga is excessively small, the disk 120 may easily collide against the air foil 170. Thus, the gap Ga may be about 50 μm.

A gap Gs between the front end 146a of the slider 146 and the air foil 170 may be as small as possible. However, the gap Gs may be about 50 μm in consideration of manufacturing issues.

In addition, the air foil 170 may be bent so as to be perpendicular to the flexure 144. That is, an angle “β” between a surface of the flexure 144 and the air foil 170 may be 90 degrees. However, the angle “β” may be equal to or more than about 80 degrees in consideration of manufacturing issues.

FIG. 7 shows a modified example of the air foil of FIG. 4 according to another exemplary embodiment of the present general inventive concept.

Referring to FIG. 7, an air foil 180 according to this exemplary embodiment may be formed by smoothly bending a portion of the flexure 144 towards the front end 146a of the slider 146. The air foil 180 includes an intermediate portion 180a connected to a neck portion 185 extending from the slider mounting portion 145 of the flexure 144 with a narrow width, and wing portions 180b extending from the intermediate portion 180a to both ends of the air foil 180. In particular, the air foil 180 according to this embodiment has a shape in which the wing portions 180b are bent towards the slider 146 by a predetermined angle while extending from the intermediate portion 180a.

Detailed dimensions of the air foil 180, for example, the width of the air foil 180, the height of the air foil 180, a gap between the air foil 180 and a line extending from an air bearing surface 146c of the slider 146, and an angle between the surface of the flexure 144 and the air foil 180 are the same as in the case of the air foil 170 illustrated in FIG. 4, and thus their detailed descriptions will not be repeated.

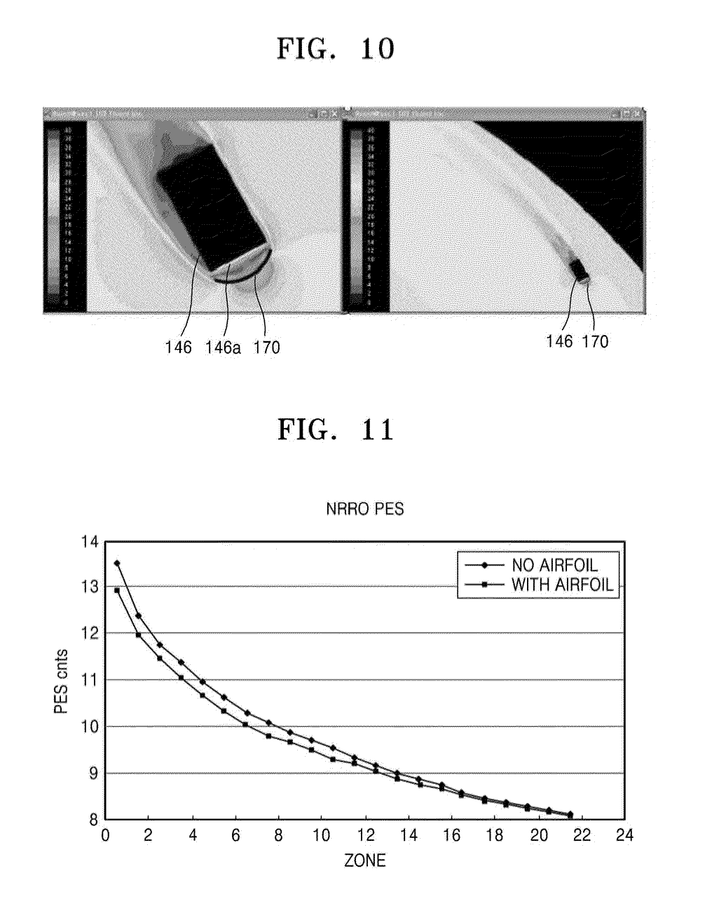

Hereinafter, the function and effects of the air foil 170 of the head gimbal assembly 140 of FIG. 4 will be described with reference to FIGS. 10 and 11.

FIG. 10 shows air flow generated in the vicinity of the slider 146 of the head gimbal assembly 140 of FIG. 4, which is above the disk 120 when the disk 120 rotates.

Referring to FIG. 10, air flow is generated due to the rotation of the disk 120. The air flow collides against the air foil 170 having a circular arc shape and installed in the front of the front end 146a of the slider 146 to be smoothly guided along both sides of the slider 146. The air flow guided along both sides of the slider 146 flows so as to be approximately in parallel to both sides of the slider 146, thereby reducing the presence of turbulent air flow in the vicinity of the slider 146. In comparison with the case of FIG. 2, it can be seen that the presence of turbulent air flow in the vicinity of the slider 146 is reduced.

As described above, when the presence of turbulent air flow in the vicinity of the slider 146 is reduced, the slider 16 oscillates less, thereby reducing a positional error signal (PES), which will be described later.

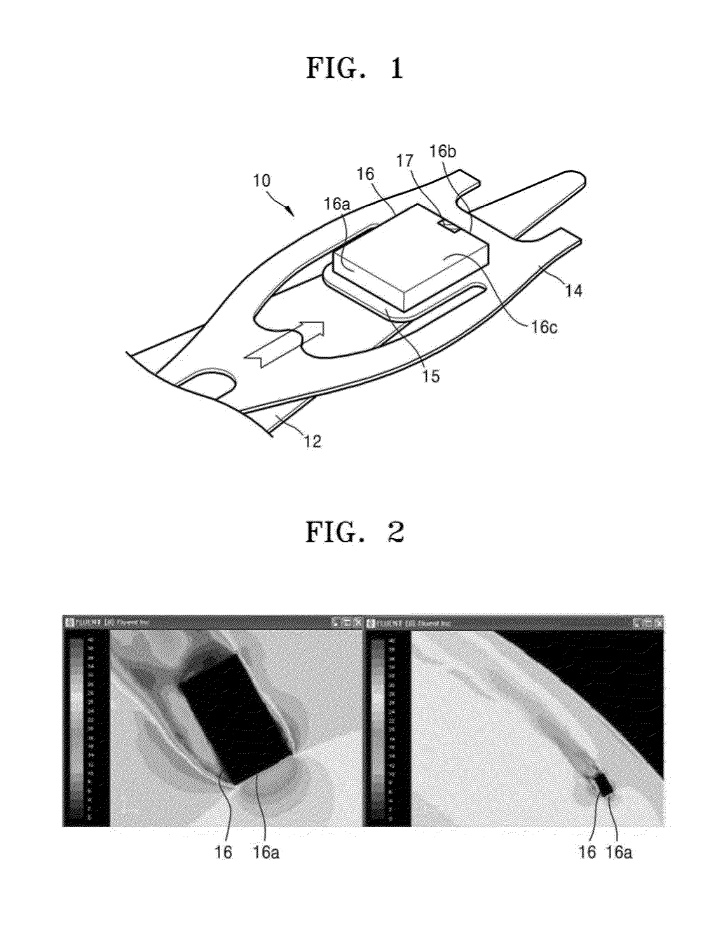

FIG. 11 is a graph showing a comparison between a non-repetitive runout (NRRO) PES in the head gimbal assembly 140 of FIG. 4 and the NRRO PES in the head gimbal assembly 10 of FIG. 1.

Referring to FIG. 11, anywhere in an HDD including the head gimbal assembly 140 with the air foil 170, the NRRO PES is less as compared to the conventional HDD with no air foil, as illustrated in FIG. 1. In particular, it can be seen that the PES is increasingly reduced from a zone “22” that is an inside zone of a disk towards a zone “0” that is an outside zone of a disk, meaning that the PES is more reduced on an outside zone of the disk, with a high linear velocity, than on the inner zone of the disk. Thus, as the revolution per minute (RPM) of a disk increase, the advantage of the air foil 170 is more apparent.

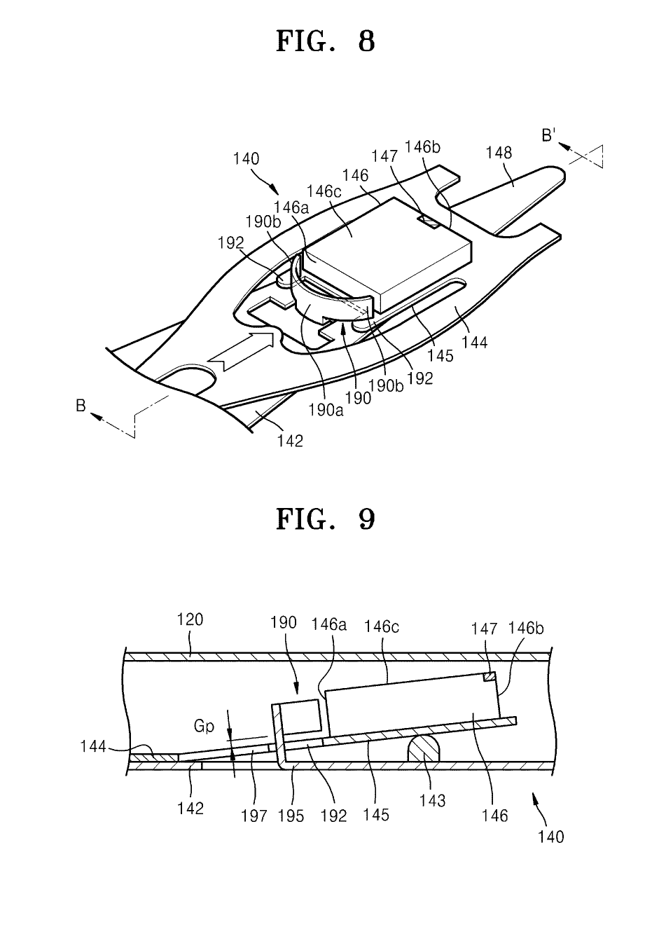

FIG. 8 is a perspective view of a head gimbal assembly 140 according to another embodiment of the present general inventive concept. FIG. 9 is a cross-sectional view of the head gimbal assembly 140 taken along line B-B′ of FIG. 8. The head gimbal assembly 140 of FIGS. 8 and 9 is the same as the head gimbal assembly 140 of FIGS. 4 through 6, except for an air foil 190, and thus the head gimbal assembly 140 according to the present embodiment will be described in terms of its differences from the head gimbal assembly 140 of FIGS. 8 and 9.

Referring to FIGS. 8 and 9, in the head gimbal assembly 140, the air foil 190 that reduces turbulent air flow in the vicinity of the slider is installed in front of the front end 146a of the slider 146. The air foil 190 may be formed by smoothly bending a portion of the load beam 142 towards the front end 146a of the slider 146. In particular, the air foil 190 formed by bending the portion of the load beam 142 is disposed through an opening 197 formed in the flexure 144 so as to be disposed in front of the front end 146a of the slider 146. The air foil 190 is connected to and supported by a neck portion 195 extending from the load beam 142.

The air foil 190 includes an intermediate portion 190a connected to the neck portion 195, and wing portions 190b extending from the intermediate portion 190a to both ends of the air foil 190. In addition, the air foil 190 may have a circular arc shape as a whole. Alternatively, the air foil 190 may have a shape in which the wing portions 190b of both ends are bent towards the slider 146 by a predetermined angle while extending from the intermediate portion 190a, like in the case of the air foil of 170 of FIG. 7.

Detailed dimensions of the air foil 190, for example, the width of the air foil 190, an inclination angle of tangent lines to the both ends of the air foil 180, the height of the air foil 190, an angle between the air foil 190 and a line extending from the air bearing surface 146c of the slider, and an angle between the surface of the flexure 144 and the air foil 190 are the same as in the case of the air foil 170 illustrated in FIG. 4, and thus their detailed description will not be repeated.

In addition, the air foil 190 having the above structure has the same function and effects as those of the air foil 170 illustrated in FIGS. 4 through 6, and thus their detailed description will not be repeated. In particular, since the air foil 190 is connected to and supported by the load beam 142, even if the air foil 190 oscillates due to the collision between the air foil 190 and air flow, these oscillations are not transferred directly to the slider 146 attached to the flexure 144. Instead, the oscillations of the air foil 190 due to the collision with air flow are transferred to the load beam 142 and absorbed by the load beam 142.

In addition, the air foil 190 may function as a limiter which limits vertical displacements of the flexure 144 and the slider 146. To achieve this, protruding portions 192 may extend from both edges of the slider mounting portion 145 of the flexure 144 between the load beam 142 and the wing portions 190b of the air foil 190. The wing portions 190b of the air foil 190 and the protruding portions 192 may be spaced apart from each other by a predetermined gap Gp.

When the slider 146 oscillates due to external shocks, and the slider 146 is separated from a surface of the disk 120 in order to park the read/write head 147, the protruding portions 192 are hooked by the wing portions 190b of the air foil 190. Thus, vertical displacements of the flexure 144 and the slider 146 are limited within the gap Gp, and thus the oscillations of the slider 146 can be reduced, and the read/write head 147 can be quickly parked.

According to various embodiments of a head gimbal assembly and an actuator of an HDD described herein, turbulent air flow in the vicinity of a slider can be reduced by an air foil installed in front of a slider. Thus, since oscillations of the slider due to turbulent air flow can be reduced, a PES of a read/write head is reduced, thereby improving data recording/reproducing performance of the read/write head.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents

What is claimed is:

1. A head gimbal assembly of a hard disk drive (HDD), elastically biasing a read/write head towards a surface of a disk, the head gimbal assembly comprising:
a load beam attached to a swing arm of an actuator;
a flexure mounted on the load beam;
a slider attached to a slider mounting portion of the flexure and comprising a read/write head installed on the slider; and
an air foil disposed in front of the slider and guiding air flow generated due to rotations of the disk along both sides of the slider.

2. The head gimbal assembly of claim 1, wherein the air foil is formed by bending a portion of the flexure towards a front end of the slider.

3. The head gimbal assembly of claim 2, wherein the air foil is connected to and supported by a neck portion extending from the slider mounting portion of the flexure.

4. The head gimbal assembly of claim 1, wherein the air foil is formed by bending a portion of the load beam towards a front end of the slider.

5. The head gimbal assembly of claim 4, wherein the air foil is disposed through an opening formed in the flexure so as to be disposed in front of the front end of the slider.

6. The head gimbal assembly of claim 4, further comprising:
protruding portions formed on both edges of the slider mounting portion of the flexure,
wherein the protruding portions extend between the air foil and the load beam, and
wherein the air foil and the protruding portions limit vertical displacements of the flexure and the slider.

7. The head gimbal assembly of claim 1, wherein the air foil comprises an intermediate portion and wing portions extending from the intermediate portion to both ends of the air foil.

8. The head gimbal assembly of claim 7, wherein the air foil has a circular arc shape.

9. The head gimbal assembly of claim 7, wherein the air foil has a shape in which the wing portions of the both ends are bent towards the slider by a predetermined angle while extending from the intermediate portion.

10. An actuator of a hard disk drive (HDD), moving a read/write head to a desired position on a disk, the actuator comprising:
a swing arm rotatably installed on a base member;
a head gimbal assembly elastically biasing the read/write head towards a surface of the disk; and
a voice coil motor rotating the swing arm,
wherein the head gimbal assembly comprises:
a load beam attached to the swing arm;
a flexure attached to the load beam;
a slider mounted on a slider mounting portion of the flexure and comprising the read/write head installed on the slider; and
an air foil disposed in front of the slider and guiding air flow generated due to rotations of the disk along both sides of the slider.

11. A slider to support a read/write head above a disk of a hard disk drive, the slider comprising:
a flexible member to support the slider with respect to the disk; and
an air foil member bent from an inner portion of the flexible member in front of a front portion of the slider in which air flow is directed when the disk rotates, the air foil member being bent upward to block the air flow from the front portion of the slider such that the air flows parallel along the sides of the slider.

12. The slider of claim 11, wherein the air foil member extends from the flexible member via a neck portion of the flexible member to face the front portion of the slider, and comprises an intermediate portion facing a middle of the front portion of the slider and wing portions extending from each side of the intermediate portion toward respective side portions of the slider.

13. The slider of claim 12, wherein the wing portions extend past respective side portions of the slider by a predetermined amount to smoothly guide the air flow along respective sides of the slider.

14. The slider of claim 12, wherein a width of the air foil is equal to or more than a width of the slider.

15. The slider of claim 11, wherein an inclination angle of tangent lines to both ends of the air foil are equal to or less than 45 degrees.

16. The slider of claim 11, wherein an inclination angle of tangent lines to both ends of the air foil are equal to or less than 25 degrees.

17. The slider of claim 11, wherein the air foil has a height equal to or more than 50% of a height of the slider.

18. The slider of claim 12, wherein the air foil is bent to be perpendicular to the flexible member.

19. The slider of claim 11, further comprising:
protruding portions formed on both edges of the inner portion of the flexible member such that the air foil and the protruding portions limit vertical displacements of the flexible member and the slider.
